(19) United States
(12) Patent Application Publication
(10) Pub. No.: US 2020/0383520 A1
(43) Pub. Date: Dec. 10, 2020

(54) SYSTEM AND METHOD FOR ASSISTIVE INTERACTIONS WITH AN AUTOMATED COOKING DEVICE

(71) Applicant: Else Labs Inc., Berkeley, CA (US)

(72) Inventors: Khalid Aboujassoum, Doha (QA); Tariq Maksoud, Glouchester (CA)

(21) Appl. No.: 16/790,458

(22) Filed: Feb. 13, 2020

Related U.S. Application Data
(63) Continuation of application No. 14/857,695, filed on Sep. 17, 2015, now abandoned.
(60) Provisional application No. 62/052,268, filed on Sep. 18, 2014.

(51) Int. Cl. A47J 36/00; G09B 5/02; G09B 19/00; A23L 5/10; F24C 7/08; A47J 36/32

(52) U.S. Cl. CPC A47J 36/00; G09B 5/02; G09B 19/0092; G05B 2219/2643; F24C 7/083; A47J 36/321; A23V 2002/00; A23L 5/10

(57) ABSTRACT

A system and method that includes selecting a first automated cooking recipe associated with user instructions and device cooking instructions; presenting the user instructions through a first controller device, which comprises providing ingredient preparation instruction and providing instruction on loading a set of ingredients in an automated cooking device; delivering cooking instructions of the automated cooking recipe to the automated cooking device; and directing a cooking routine of the automated cooking device according to the cooking instructions.

### CROSS-REFERENCE TO RELATED APPLICATIONS

This Application is a continuation application of U.S. Non-Provisional application Ser. No. 14/857,695, filed on 17 Sep. 2015, which claims the benefit of U.S. Provisional Application No. 62/052,268, filed on 18 Sep. 2014, both of which are incorporated in their entirety by this reference.

### TECHNICAL FIELD

This invention relates generally to the field of automated cooking, and more specifically to a new and useful system and method for assistive interactions with an automated cooking device.

### BACKGROUND

Modern life has had a significant impact on cooking and eating habits. There is increasing demand for high quality healthy food, and people are requiring convenient and on-demand features for many traditional products and services. However, no existing solution delivers a value that satisfies the demand for healthy and convenient food preparation. Microwaves, slow-cookers, and rice-cookers provide convenience, but the convenience comes at the cost of meal quality. On the other hand, the conventional stove is very time and labor intensive, which makes it very intimidating and inconvenient for many people. Thus, there is a need in the automated cooking field to create a new and useful system and method for assistive interactions with an automated cooking device. This invention provides such a new and useful system and method.

### BRIEF DESCRIPTION OF THE FIGS.

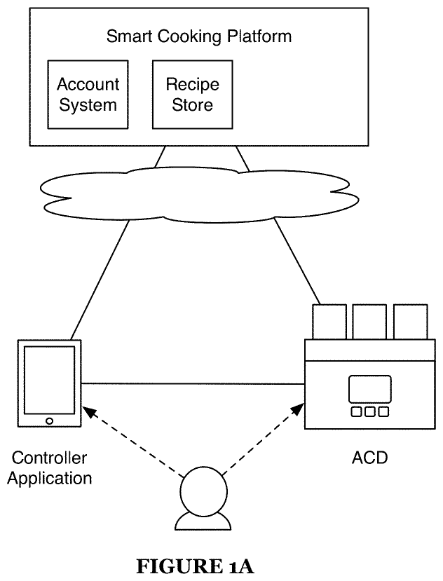

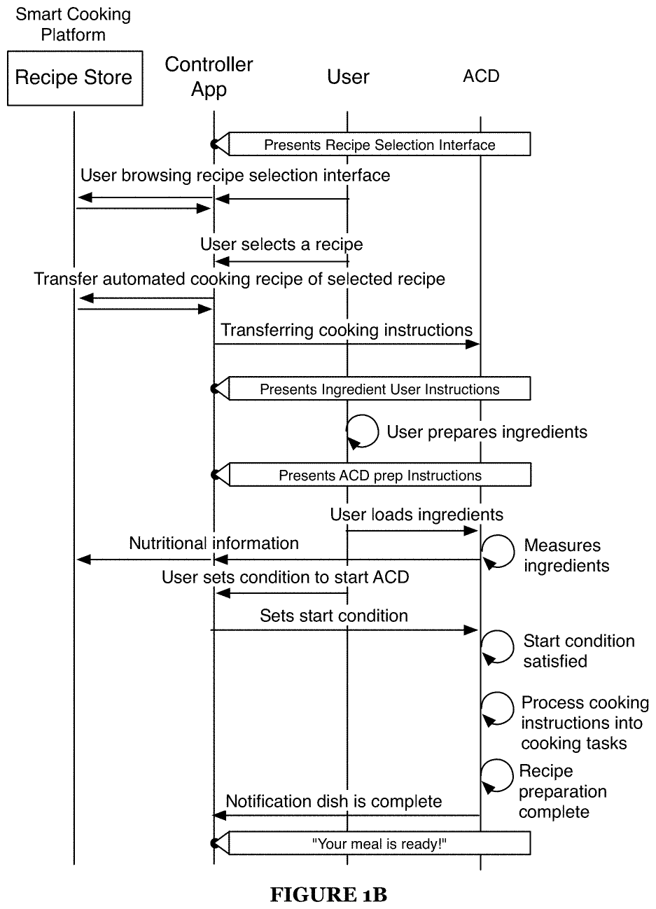

FIG. 1A is a an illustrative representation of a system of a preferred embodiment;

FIG. 1B is an interaction flow diagram of an exemplary use of the system and method;

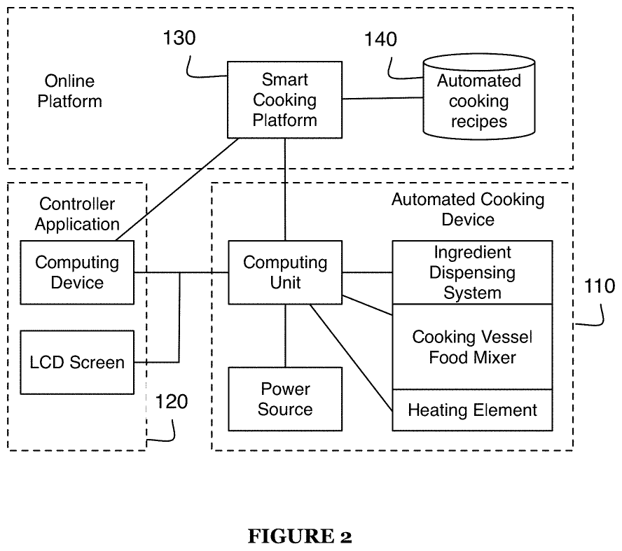

FIG. 2 is a detailed schematic representation of a system of a preferred embodiment;

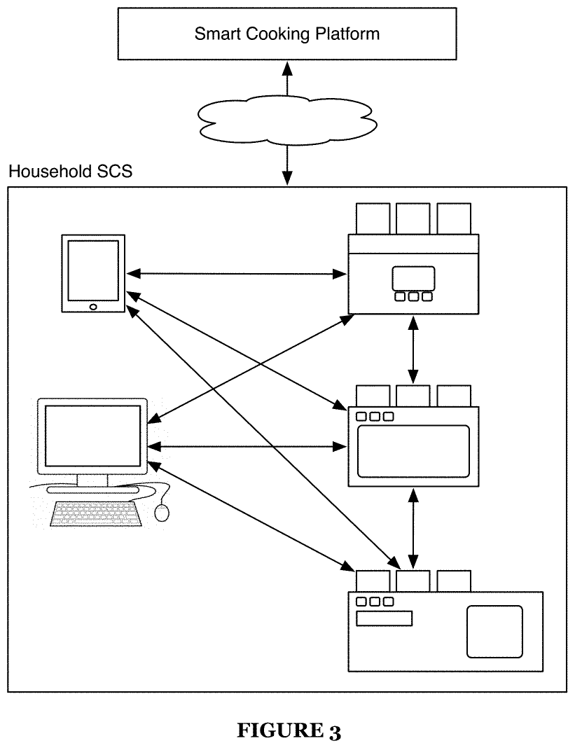

FIG. 3 is a schematic representation of a smart cooking system with multiple automated cooking device types;

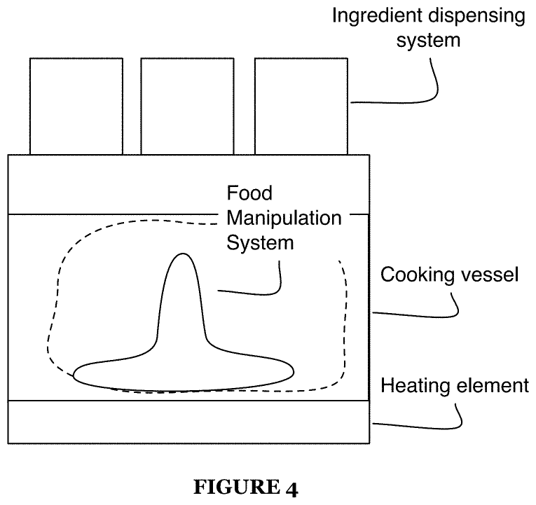

FIG. 4 is a schematic representation of an exemplary automated cooking device;

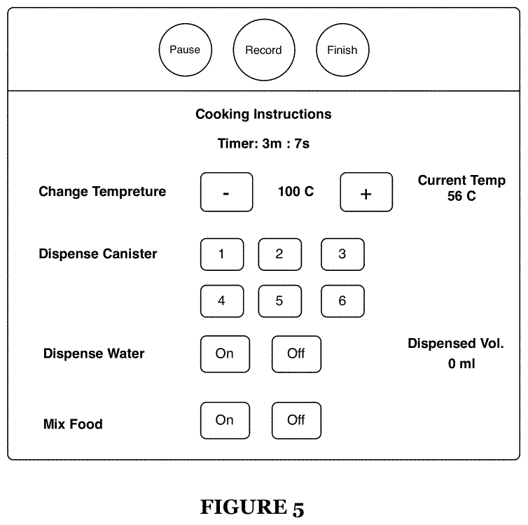

FIG. 5 is an exemplary representation of an automated cooking device controller interface;

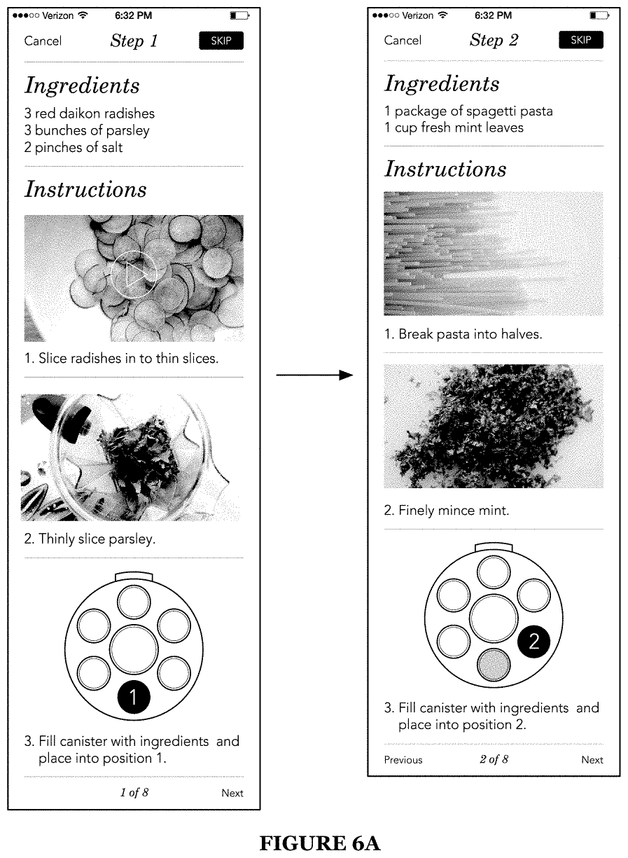

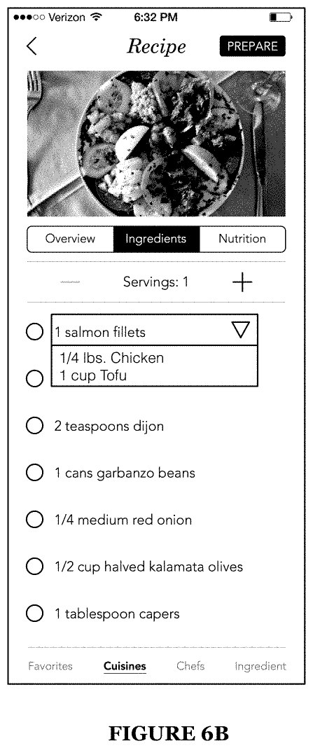

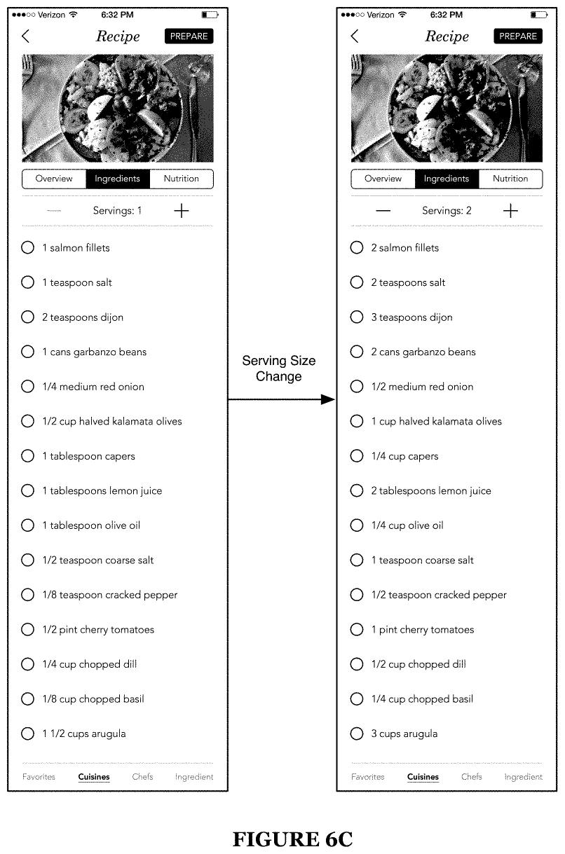

FIGS. 6A, 6B, and 6C are exemplary representations of a recipe instruction interface;

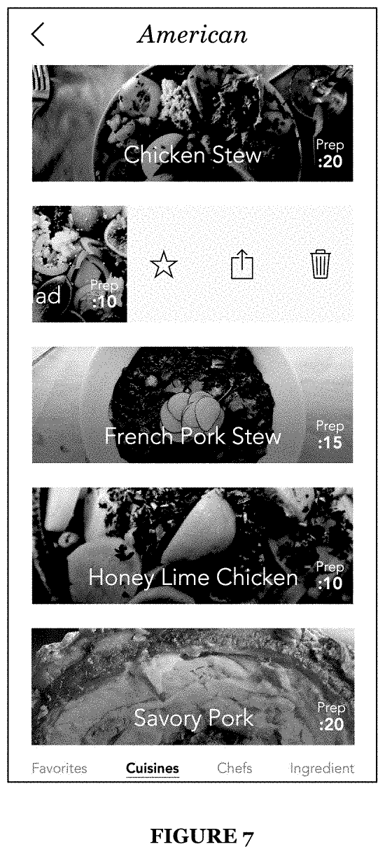

FIG. 7 is an exemplary representation of a recipe store interface;

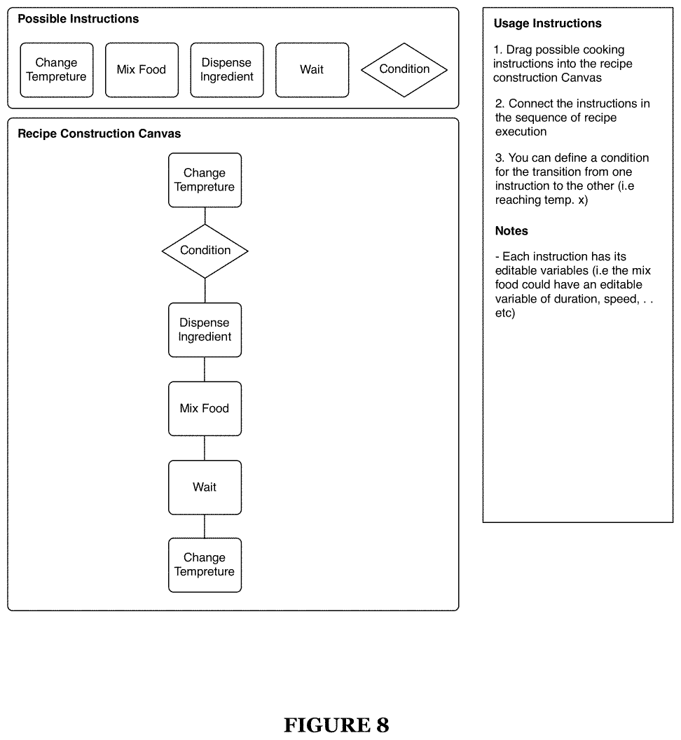

FIG. 8 is an exemplary representation of a recipe creation tool;

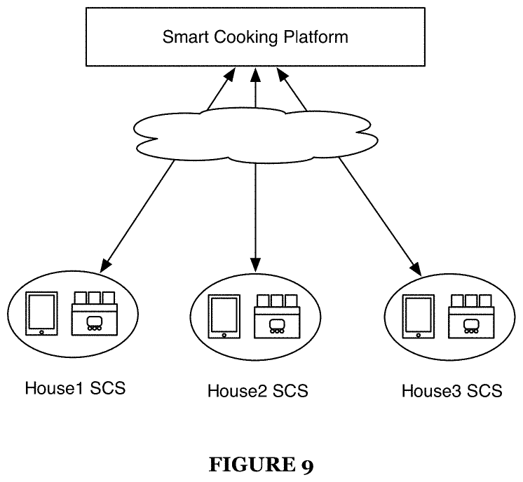

FIG. 9 is schematic representation of the multitenant implementation of the smart cooking platform;

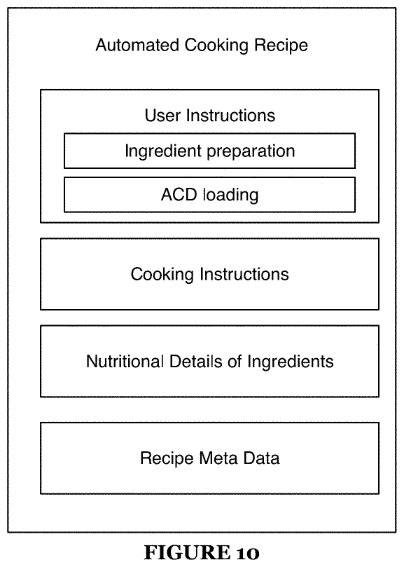

FIG. 10 is an object representation of an automated cooking recipe file;

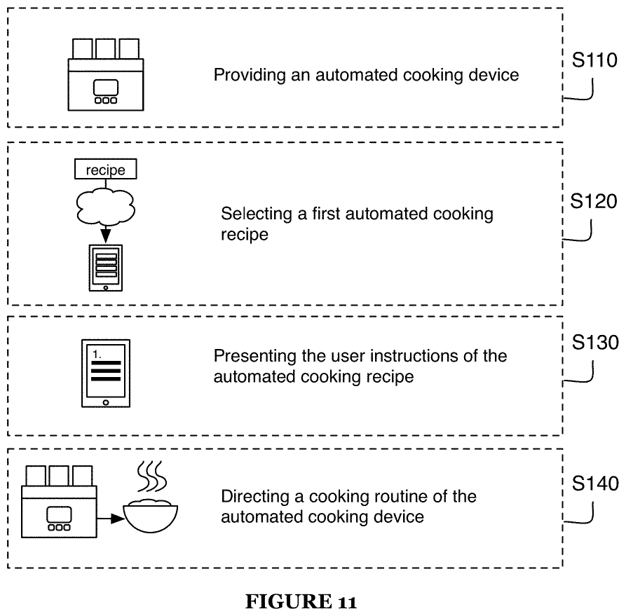

FIG. 11 is a process chart representation of a method of a preferred embodiment;

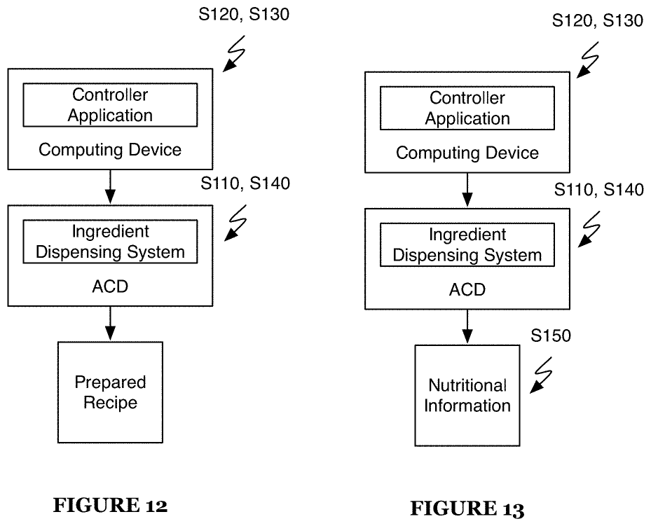

FIGS. 12-17 are method variations of preferred embodiments;

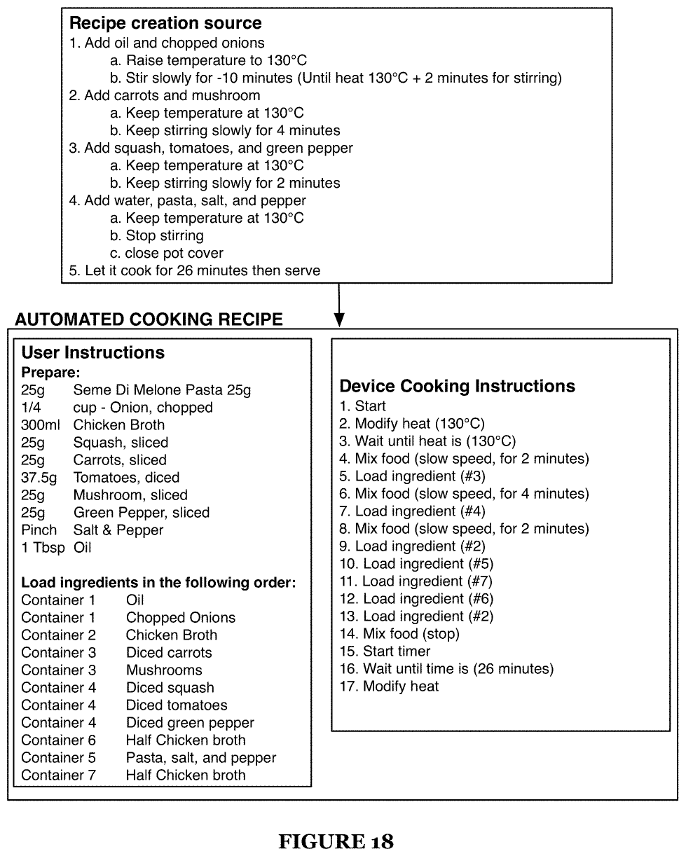

FIG. 18 is a exemplary representation of converting a recipe to an automated cooking recipe;

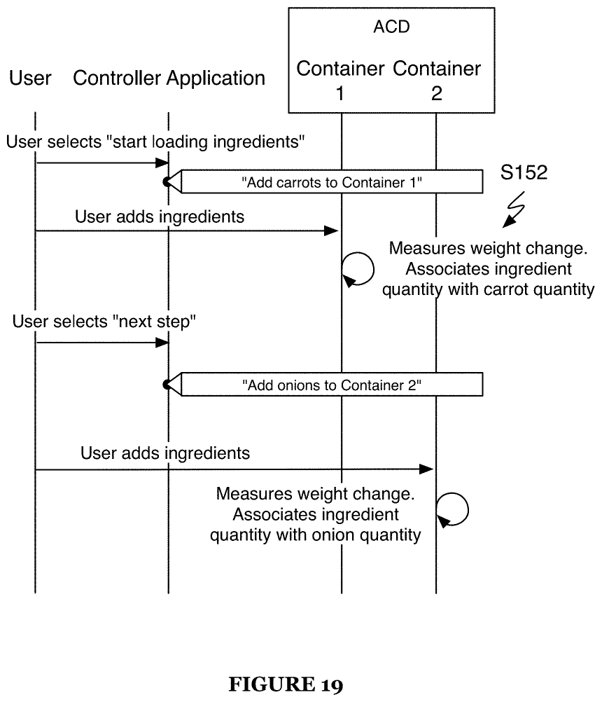

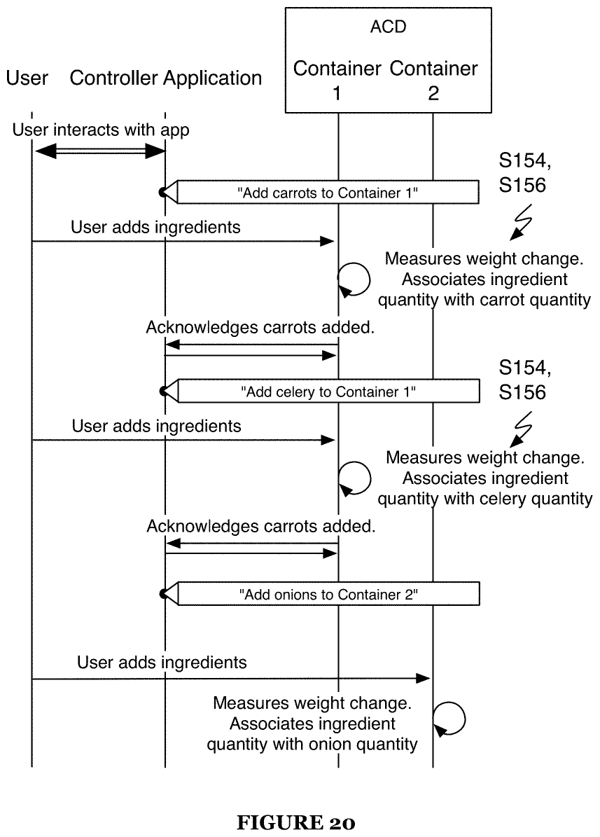

FIGS. 19 and 20 are interaction flow diagrams representing exemplary ACD preparation instruction interactions;

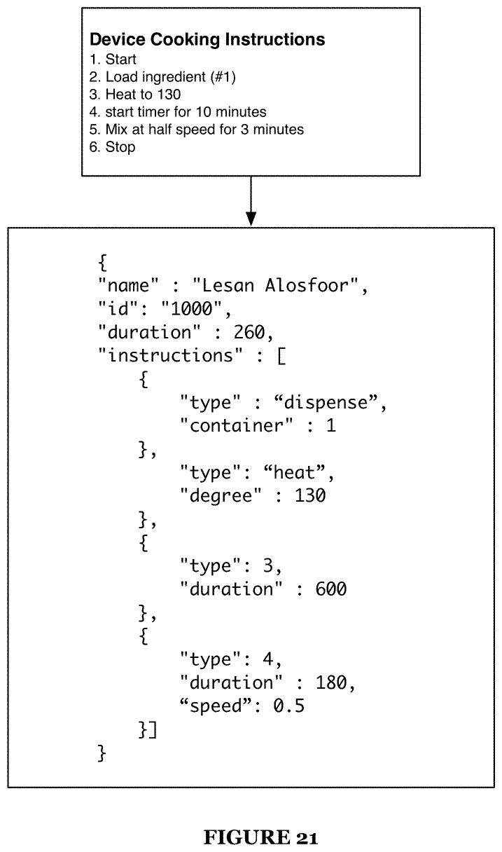

FIG. 21 is an exemplary representation of machine readable cooking instructions;

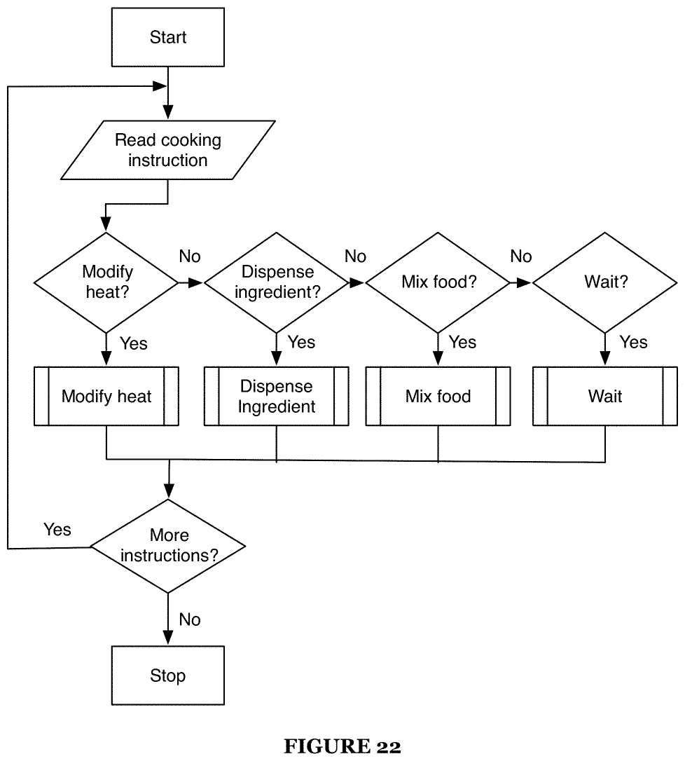

FIG. 22 is a flow diagram of processing cooking instructions into cooking tasks;

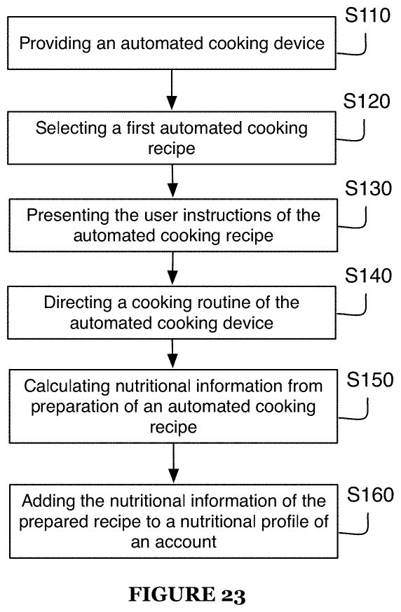

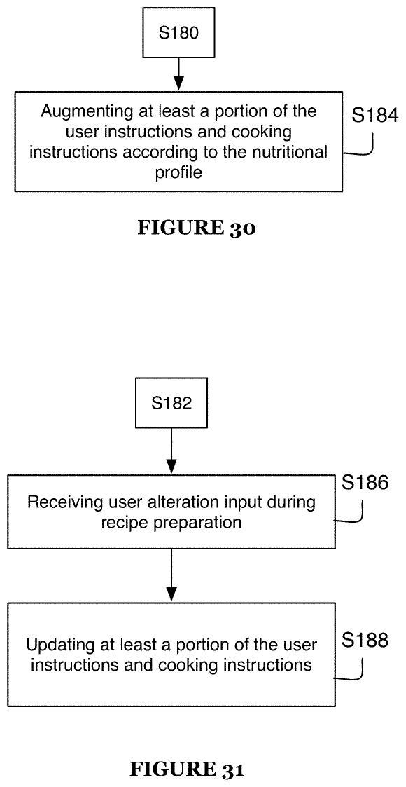

FIGS. 23-31 are method flow diagrams of variations of preferred embodiments;

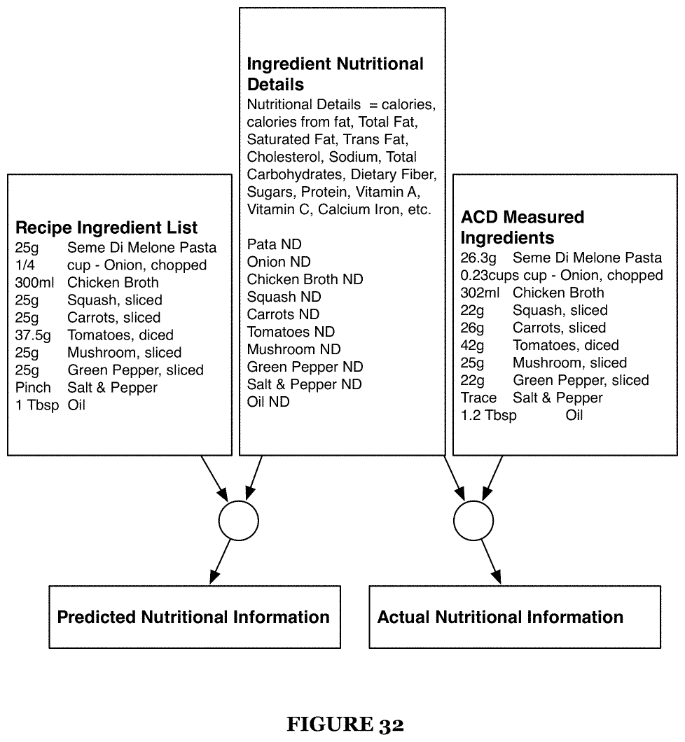

FIG. 32 is a schematic representation of generating nutritional information for a recipe preparation; and

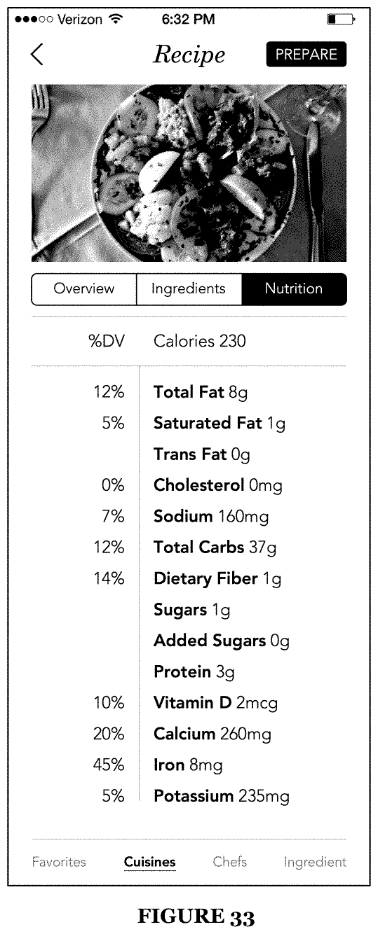

FIG. 33 is a screenshot representation of nutritional information.

### DESCRIPTION OF THE EMBODIMENTS

The following description of the embodiments of the invention is not intended to limit the invention to these embodiments but rather to enable a person skilled in the art to make and use this invention.

### 1. Overview

As shown in FIGS. 1A and 1B, a system and method for assistive interactions with an automated cooking device (ACD) functions to perform a smart cooking process. More specifically, the system and method can function to provide a convenient interaction process in controlling an ACD. In certain embodiments, a smart cooking system (SCS) uses the advantages of connecting a device to the cloud and automates the cooking process for personal use by providing a richer cooking and food consumption experience. As a primary objective, the system and method addresses the user interaction and control of an ACD. The user may select a pre-programmed recipe and may follow the instructions on loading the recipe ingredients into their designated containers. Then, the user can command the ACD to start the cooking process immediately, after a pre-defined time, and/or at a particular time.

The system and method can function to enable a user to conveniently use an application on an external computing device or an ACD control interface to select a recipe and be guided through a cooking preparation process. That application can then coordinate with an ACD in executing an automated cooking process. Such coordinated control interaction can be particularly beneficial to a smart cooking system (SCS) that promotes at least partial user involvement during recipe preparation, which can allow for ingredient amount customization, ingredient variety customization, ingredient substitution, and other forms of user-controlled recipe modifications. For example, the SCS can enable fresh ingredients to be prepared and loaded or otherwise delivered to the ACD. A user may have a particular preference for one brand of ingredient over another. Preloaded ingredient containers can reduce such flexibility. Additionally, automated meal preparation can enable users to conserve money by avoiding eating out, conserve time by automating part of the cooking process, and eat healthier by enabling the use of fresh ingredients.

The system and method can additionally function to collect nutritional information through use of the ACD. As discussed, one potential usability benefit of the ACD can be the use of fresh ingredients as well as customization of a recipe during user preparation. The system and method can account for such recipe customizations through a recipe modification tool (e.g., recipe creation tool) of an application or through an ingredient sensing process of the ACD. The customization of a recipe can generate nutritional information relating to a particular instance of recipe preparation. Recipe preparation can involve the preparation of ingredients and/or the cooking process of the ACD. In one variation, a historical nutritional profile of one ACD can be tracked for a single user. Alternatively, the historical nutritional profile can be tracked for multiple users that eat at least a partial serving from the ACD. In another variation, a nutritional profile can be tracked across multiple ACDs if, for example, a user has multiple types of ACD that are used for different recipes.

Additionally, the system and method can function to accommodate an ecosystem of recipe sharing, customization, and selling. A recipe creation tool can enable chefs or users to create new recipes shared through a platform. Additionally, recipes can be altered or otherwise customized by users.

### 2. Smart Cooking System

As shown in FIG. 2 a Smart Cooking System (SCS) for assistive interactions with an automated cooking devices can include at least one ACD 110, a controller application 120, a smart cooking platform 130, and a set of automated cooking recipes (ACRs) 140. During use of the system, a user may select a pre-programmed recipe and may follow the instructions of preparing and loading the recipe ingredients into their designated containers. Then, the user could command the ACD to start the cooking process immediately, after a pre-defined time, at a particular time, or in response to any detectable event (e.g., the user leaves work).

The SCS can include preprogrammed recipes that provide total convenience to the user as using the SCS doesn't require any background in cooking. The user selects a pre-programmed recipe and follows the instructions of loading the recipe ingredients into their designated containers. According to certain embodiments of the present invention, a user may choose how many servings are to be cooked, and embodiments of the present invention will update the ingredient quantities in the instructions accordingly. In one example embodiment, the appliance (such as the automatic cooking pot) cooks up to 3 servings of each available recipe. The user may command the SCS to start the cooking process immediately, after a pre-defined time, or at a specified time. Given the volume and weight of the ingredients, the SCS connects to the cloud to provide ingredient nutritional details of the recipe to be cooked. Furthermore, it records and archives the nutritional information of the prepared recipe for the purpose of nutritional tracking.

### Automated Cooking Device

There is at least one ACD no functions as a cooking instrument that can automate a sequence of cooking steps to produce a prepared meal (e.g., a meal, food item, dish). The automated cooking device may be a cooking robot, a food preparation machine, or any suitable cooking system. An ACD preferably automates at least a portion of cooking task including changing temperature, dispensing ingredients, physical manipulation of food (e.g., stirring, flipping, mixing, mashing, etc.), and waiting.

The automated cooking device can include a set of cooking systems to facilitate cooking automation. The cooking systems can include a heating system, an ingredient dispensing system, and a food manipulation system as shown in FIG. 4.

A heating system can include a stovetop cooking system, a fryer system, a microwave system, a grill system, a baking system, a refrigeration system, and/or any suitable temperature modification system. In a preferred embodiment, a given ACD 110 preferably has a single primary heating system. For example, there may be a stovetop ACD, an oven ACD, a grill ACD, and the like. S1milarly, the SCS can include a single type of ACD, but the SCS may additionally include multiple types of ACDs as shown in FIG. 3. Multiple ACDs can be configured to operate cooperatively within a kitchen environment. For example, a household may use a stovetop ACD and an oven ACD. Meals prepared using one or more ACDs can be monitored and controlled.

An ingredient dispensing system functions to dispense a set of ingredients into a cooking apparatus at different stages. The cooking apparatus (e.g., a pot or pan) is preferably part of a heating system. For example, the ingredient dispensing system may selectively add different groups of ingredients to a pot. In one variation, an ACD can include multiple stations of an ACD where different processes occur, and an ingredient dispensing system or other suitable mechanism may be used in transferring ingredients between stations. An ingredient dispensing system can control at least the timing of ingredient delivery to a cooking apparatus. For example, a set of containers may include a controllable dispensing mechanism for when ingredients are dispensed. In one implementation, ingredient containers include an actuated door that can be opened on command to release ingredients. Additionally, an ingredient dispensing system may additionally include a quantity control mechanism, wherein the amount of ingredients can be controlled. Specialized ingredient containers may additionally be included in an ingredient dispensing system. For example, at least part of an ingredient dispensing system can include a spice dispensing mechanism, a water dispensing mechanism, and an oil dispensing mechanism, which can dispense controlled amounts at different instances.

In one particular implementation, the ingredient dispensing system includes an ingredients tray that includes a set of ingredient containers. An ingredient container is preferably a vessel with a defined cavity in which ingredients can be deposited and held. An ingredient container is preferably capable of managing a wide and diverse range of ingredients with different states (liquid, solid, grounded, paste, etc.) and different quantities/volumes. An ingredient container preferably has a controllable dispensing mode wherein contained ingredients are dispensed when the ingredient container is engaged in the dispensing mode. Selective activation of the dispensing mode of at least one ingredient container functions to enable ingredients to be dispensed at distinct stages. The set of ingredient containers is preferably supplied with ingredients by a user. Alternatively, the ingredients may be supplied in an automated or alternative manner.

The ingredient dispensing system preferably enables an easier way for managing ingredients. The ingredient containers may be designed to take multiple ingredients at once; which enables grouping ingredients of different types, volumes, and quantities. This, in turn, influences the recipe structure and the way embodiments of the present invention design the ingredients preparation instructions (since now ingredients are grouped in defined containers). For example, a first container may be supplied with onions, potatoes, and green peppers, and a second container may be supplied with chicken cubes with salt and pepper.

Some of the ingredient containers may be dedicated for liquid ingredients and other ingredient containers may be dedicated for all other types of ingredients. In certain embodiments, there may be physical differences between containers dedicated for liquid ingredients as compared to containers dedicated for non-liquid ingredients. For example, the different types of containers may have different sealing and dispensing components/mechanisms. The liquid containers may be configured to only take liquid and dispense liquid. Certain liquid containers may be directed at dispensing water. The containers may use solenoid valves and linear actuators to seal and dispense contents.

An ingredient container or other component of the ACD can include ingredient sensors. The ingredient sensors function to measure and/or quantify the amount of a particular ingredient is supplied to the ACD. An ingredient container can be a volumetric sensor, a load cell to measure ingredient weight, a vision system, and/or any suitable type of sensor element. The ingredient sensors can be used in calculating nutritional information of a prepared recipe—the measured ingredient amount used during recipe preparation is used in combination to calculate an actual approximation of the nutritional value of a meal. Additionally, ingredient measurement can be used in automatic customization of cooking instructions. If a user decides to use twice as much chicken as suggested by a recipe, the ingredient sensors can detect this difference and automatically update the heating temperature and/or time.

An ACD may additionally include a food manipulation system, which functions to move and/or physically act on a portion of ingredients. The food manipulation can occur before, during, after a cooking process. The food manipulation system can stir, mix, flip, press, move, rotate, chop, dice, cut, grate, and/or perform any suitable form of physical manipulation. The form of food manipulation can additionally include various modes of operation. For example, stirring can be performed at different speeds. The ACD may alternatively not include such a food manipulation system.

The ACD can additionally include a microcontroller or other suitable computing unit elements. The computing unit can preferably translate cooking instructions of an automated cooking recipe into a set of cooking tasks to form a cooking routine. Alternatively, the translation may be performed on a secondary device or in the cloud and a set of cooking task instructions can be delivered to the ACD for execution. In one variation, the ACD can include a control panel, which can include user input elements such as buttons, switches, touch screens, dials, or any suitable form of user input. The ACD can include a display such as an LCD screen. The ACD may additionally include a speaker for playing audio feedback. Additionally, the ACD includes communication components such as a Bluetooth module, a Wi-Fi module, or any suitable communication component. The communication component can enable the ACD to connect to a network (e.g., a local network or the internet) to one or more devices such as the device of the controller application 120. The ACD can include preprogrammed multi-stage cooking routines pre-built into the device for common cooking process. However, the ACD is preferably responsive to cooking instructions provided by a selected controller application or smart cooking platform.

### Controller Application

The controller application 120 functions to provide a control interface to the ACD. The controller application 120 is preferably an application operative on a personal computing device such as a phone, tablet, wearable device, a computer, a TV computing device, or any suitable computing device. The personal computing device preferably includes a graphical display, user input mechanism (e.g., touch screen keyboard and mouse, or any suitable user interface elements), a computing unit for program execution, and a communication connection (e.g., Wi-Fi, cellular data connection, Bluetooth, or any suitable element to communicate over a communication channel). The use of a controller application 120 operative on a second device can be a more convenient and cost effective way to provide a rich user interaction interface. Additionally, a controller application 120 on a second device can enable remote control of the ACD. A controller application 120 is preferably synced to at least one ACD, but can alternatively be connected to multiple ACDs as shown in FIG. 3. S1milarly, multiple instances of a controller application 120 can be connected to a single ACD. The controller application 120 may alternatively or additionally be operative through the user-interface components of the ACD.

The controller application 120 can include multiple control interfaces such as an ACD controller, a recipe instruction interface, a recipe store, a recipe creation tool, and/or any suitable type of interface.

An ACD controller interface functions to provide basic controls of the ACD on the secondary device as shown in FIG. 5. At least a subset of the controls offered directly through the actual ACD can alternatively be managed through an ACD controller interface. Basic controls could include starting a cooking process, pausing a cooking process, canceling a cooking process, changing settings of a cooking process, and/or taking any suitable action. An ACD controller interfaced can additionally serve to record a cooking process and be used as a recipe creation tool. The ACD controller interface can additionally provide user feedback about the current state of the ACD, such as cooking stage, a time estimate for dish completion, displaying notifications, displaying error and warning alerts, and/or presenting any suitable type of information.

A recipe instruction interface functions to provide recipe instructions to a user when preparing a selected recipe as shown in FIG. 6A. A user will preferably select an automated cooking recipe to prepare from the recipe store or any suitable recipe selection interface. The recipe will preferably include a set of user instructions that are used in presented to the user through the recipe instruction interface. The user instructions can include ingredient preparation user instructions and ACD preparation user instructions. The user instructions may alternatively be divided in any suitable manner. The displayed user instructions can provide instructions relating to required ingredients, quantities of ingredients, preparation of ingredients (e.g., “cut the carrots into small cubes”), how to load ingredients in an ACD, and/or any suitable cooking instruction. The ACD preferably performs most or all of the actual cooking process, but some preliminary ingredient preparation steps may be specified in the recipe instruction interface. S1nce an ACD can use grouped ingredients, the recipe instruction interface preferably provides instructions on which ingredients should be added to which container. The ingredient loading instructions may additionally be provided in an ordered, modular manner, which functions to enable the SCS to correlate a specific ingredient with the detected ingredient quantity measured by the ACD. For example, a recipe may have two ingredient groups—a first ingredient group can have carrots and broccoli and a second ingredient group can have chicken cubes. In this example, the ingredient instruction interface may guide a user in ingredient preparation and then transition to an ingredient loading mode. In the ingredient loading mode, the recipe instruction interface can first specify to load the carrots in a first container. Then, after detecting the carrots were loaded or after the user requests the next step, the recipe instruction interface can specify to load the broccoli in the first container. Last, the recipe instruction interface can specify to load the chicken cubes in a second container.

The recipe instruction interface can additionally provide customization options through recipe modification tools or any suitable user input element as shown in FIG. 6B or 6C. The recipe instruction interface can include user interface elements such as form inputs, dropdowns, or other suitable inputs tools. The customization options can include serving size option, ingredient quantities, ingredient substitution options, food preparation preferences (e.g., well done vs. rare), and/or any suitable type of recipe modification. Modification of a recipe made through a recipe instruction interface can be saved and used in calculating nutritional information for a prepared recipe. Customization of a recipe preferably updates the user instructions and the cooking instructions for the ACD appropriately.

The recipe store interface functions to be a gallery of selectable recipes that can be used with an ACD as shown in FIG. 7. More generally, the recipe store interface is a recipe selection interface. As described below, a recipe can include the user instructions and the ACD instructions. The recipe store interface can be a locally stored menu of recipe options. The recipe store may alternatively be an online gallery. The recipe store can provide any suitable type of marketplace offering. For example, the recipe store can include searching, recipe filtering, browsing by category, displaying featured or curated recipes, offering a social network features (e.g., following, liking, reposting, etc.), and/or any suitable features. There can be free and/or paid recipes.

The system can additionally include a recipe creation tool. A recipe creation tool functions enable a user to author new or modified recipes as shown in FIG. 8. The recipe creation tool may be offered as an integrated portion of the controller application 120, but the recipe creation tool may alternatively be a distinct application. For example, the recipe creation tool may be a web application accessible through a website of the smart cooking platform. The recipe creation tool may alternatively be a native application. The recipe creation tool generates automated cooking recipes compatible with the SCS and that run on an ACD or any smart appliance supported by the SCS. The recipe creation tool can include tools to create a set of user instructions and create a set of ACD instructions. Tools can enable entering ingredient quantities, preparation steps, ingredient loading instructions, setting the cooking process of the ACD, and/or specifying any suitable aspect of an automated cooking recipe. Created recipes may be uploaded to the recipe store for distribution. The created recipes may alternatively be saved locally and shared in any suitable manner. In one variation, a new recipe can be created by “forking” another recipe, wherein an existing recipe is used as a starting point but is then edited.

### Smart Cooking Platform

The smart cooking platform 130 functions to provide a centralized platform for managing various aspects of the SCS. The smart cooking platform 130 is preferably an internet platform hosted on a distributed computing infrastructure, a cloud computing system, or any suitable computing system. The smart cooking platform 130 can include an account system to manage account settings and actions. An account may be associated with a particular entity wherein the entity could be a person, a household, an ACD, or any suitable entity. Basic configurations of an account such as name, preferences, health information, dietary restrictions, and other sort of information can be synchronized through the smart cooking platform 130. Additionally, account history can track what recipes are browsed and/or selected. This can be used in recommending new recipes to a user.

The smart cooking platform 130 is preferably a multitenant platform where multiple SCSs of different homes can be coordinated by the smart cooking platform. Each house with an ACD preferably uses at least one account that accesses the smart cooking platform 130 as shown in FIG. 9.

The smart cooking platform can additionally host, distribute, and manage automated cooking recipes. The recipe store described above preferably provides an interface to access the automated cooking recipes of the smart cooking platform 130.

The smart cooking platform can additionally manage a nutritional profile system, which can be used in calculating nutritional value of prepared recipes, tracking nutritional history of an account, and/or generating nutritional recommendations. In a preferred implementation, the nutritional aspects of a user or users diets can be tracked through use of the ACD. The nutritional tracking can be highly customized, accounting for serving sizes, ingredient proportions, and eating history. The SCS can automatically act to improve nutrition through modifying recipes and/or altering recipe recommendations in the recipe store.

The smart cooking platform 130 can additionally include an application programming interface (API), which may be used to enable other services and/or devices to interact with the data of the SCS, the recipe store, and the nutritional profile system.

### Automated Cooking Recipes

The set of automated cooking recipes 140 function as a data object encapsulating instructions for rendering user instructions and executing a sequence of cooking tasks by an ACD as specified. An automated cooking recipe, herein sometimes referred simply as a recipe, can be a file, a set of files, or another form of a data resource. In one variation, the automated cooking recipe can be a formatted script file using an xml format, a json format, or any suitable type of structured representation. An automated cooking recipe can include meta data portion, a user instruction portion, and a cooking instruction portion as shown in FIG. 10. The automated cooking recipe may additionally include nutritional details of the ingredients. Alternatively, the nutritional details may be stored and accessed through a remote system. For example, the nutritional details can be stored in a database. The meta data portion can specify a recipe name, recipe author, a recipe description, a recipe image, historical notes, pairing recommendations, drink recommendations, and/or any suitable type of metadata. A smart cooking platform can additionally manage other information such as the recipe rating, multiple user-submitted photos, recipe reviews, and the like. The user instruction portion can include ingredient preparation instructions and ACD preparation instructions. The ingredient preparation preferably provides guidance on what ingredients are required, the quantity of the ingredients, and any initial preparation that a user should complete. The ACD preparation instructions can guide loading the ingredients and any setup of the ACD. These instructions may include written description, graphics, or any suitable media-representation of an instruction. The cooking instruction portion is preferably ACD interpretable instructions that can be translated into a cooking routine. The cooking routine is preferably a set of various cooking tasks executed by the ACD at particular conditions (e.g., time conditions, temperature conditions, or food state conditions). As one example, the cooking instructions may be translated into the sequence of cooking tasks like: heat to 300, dispense container 1, stir on high, wait 3 minutes, turn off stirring, dispense container 2, set heat to 200, stir at low, wait for 5 minutes, dispense container 3, wait for 5 minutes, stop stirring.

3. Method for Assistive Interactions with an Automated Cooking Device

As shown in FIG. 11, a method for assistive interactions with an automated cooking device of a preferred embodiment can include providing an automated cooking device S110, selecting a first automated cooking recipe S120, presenting the user instructions of the automated cooking recipe S130, directing a cooking routine of the automated cooking device S140. The method is preferably implemented through a smart cooking system such as the one described above. The method preferably functions to use a controller application and an automated cooking device to produce a prepared recipe as shown in FIG. 12. The method can additionally address generating nutritional information promoting improved eating decisions, and enabling customization of recipes among other uses. One potential benefit of the method is the automation of the cooking process around user participation. Enabling some level of user participation may promote the perception of an improved cooking and eating experience. The user participation in preparing the ingredients, loading of ingredients into an ACD, and/or customization of a recipe can empower the user to opt for preparing healthier eating decisions. The method functions to facilitate the use and operation of an ACD of a SCS where the ACD has loaded ingredients.

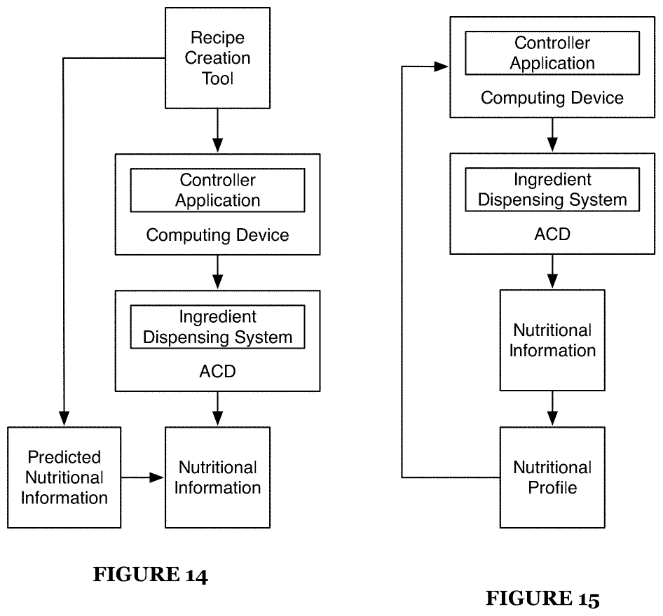

The method can additionally address other benefits of a SCS. With regard to nutritional aspects of a SCS, the method may additionally or alternatively be directed at tracking nutritional aspects of prepared recipes and/or promoting improved nutrition through use of the SCS as shown in FIG. 13. Recipe nutritional information may be specifically calculated for each instance of recipe preparation by detecting modifications during user preparation of the automated cooking recipe and/or by measuring ingredient quantities supplied to an ACD as shown in FIG. 32. Certain embodiments of the present invention may capture and archive the nutritional details using the stored data (ingredient quantity per serving) in each recipe. Certain embodiments of the present invention may also perform independent measurements on each ingredient (e.g., using sensors to measure volume/weight when the ingredient is loaded) to increase the accuracy of measuring the nutritional details. Nutritional information may additionally be generated when the recipe is a user created recipe as shown in FIG. 14. A recipe creation tool would generate a recipe that preferably embeds the nutritional details of the ingredients.

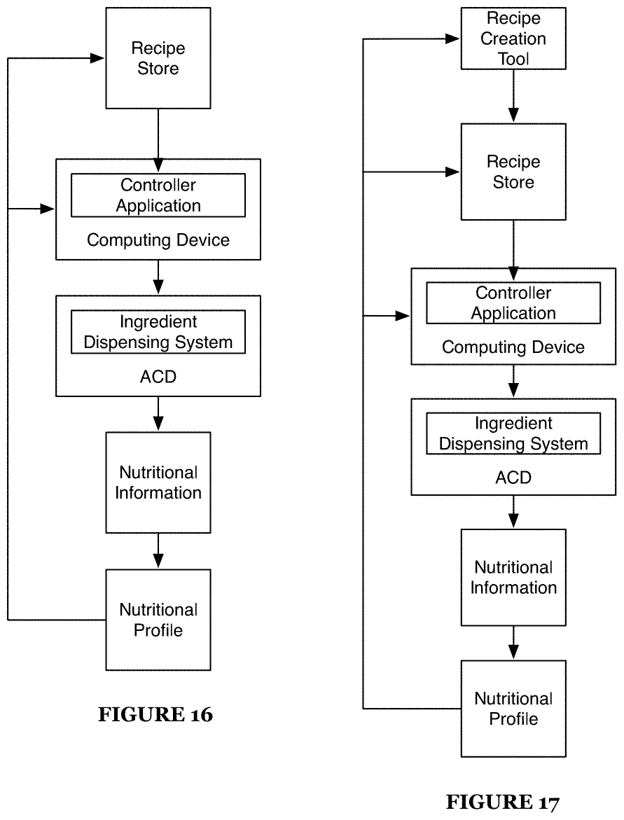

The method may additionally or alternatively be directed at use of a recipe store as shown in FIG. 16 and/or the creation of automated cooking recipes for an ACD as shown in FIG. 17. Various aspects of using a SCS can be augmented including use of a controller application or ACD as shown in FIG. 15, use of the recipe store as shown in FIG. 16, and/or the use of a recipe creation tool as shown in FIG. 17. Additionally, various tools may be provided to support the alteration or creation of automated cooking recipes.

Block S110, which includes providing an automated cooking device, functions to supply a cooking appliance that facilitates at least partial preparation of a meal. More generally, the method can include providing a smart cooking system. The smart cooking system is preferably substantially similar to the one described above. The smart cooking system can include the ACD, a controller application, a smart cooking platform, and/or a set of automated cooking recipes. The smart cooking system can include any alternative or additional elements.

The ACD can be a staged ingredient cooking device. As a first characteristic of a staged ingredient cooking device, the ACD receives ingredients supplied through user loading of the ingredients. As a second characteristic of a staged ingredient cooking device, the ACD includes an ingredient dispensing system that can dispense a set of ingredient types at different instances. The ACD can be any suitable type of cooking device such as a stovetop cooker, an oven cooker, a wok cooker, a grill cooker, and/or any suitable type of cooking device.

Block S120, which includes selecting a first automated cooking recipe, functions to receive selection input of at least one recipe. An automated cooking recipe preferably includes an associated set of user instructions and a set of device cooking instructions as shown in FIG. 10. Selecting of a first automated cooking recipe can occur on a controller application, which may be operable on the ACD or on a secondary device such as a remote control or a smart phone. The controller application preferably includes a recipe selection interface through which a set of preloaded recipes or recipes from an online marketplace may be accessed. The controller application can preferably communicate with the ACD.

Selecting the automated cooking recipe can include rendering at the recipe selection interface a set of menu options on the recipe selection interface and receiving user selection of an item associated with the automated cooking recipe. The menu of options can provide searching, filtering, category browsing, social browsing, browsing of curated sets of recipes, or any suitable type of recipe explorations. The menu of options can include recipe items downloaded from a smart cooking platform, installed locally, and/or accessed from any suitable source. Selection of a recipe may require permission to access the recipe. Permissions can be granted to an account that pays for one or more recipes, has a platform subscription, possesses a qualifying social connection, and/or satisfies any suitable condition.

Once a recipe is selected at least the user instructions associated with the automated cooking recipe can be downloaded or accessed by the controller application.

Block S130, which includes presenting user instructions of the automated cooking recipe, functions to render directions guiding a user through ingredient preparation and ACD setup. Presenting user instructions can include providing at least two types of user instructions: ingredient preparation instructions and ACD preparation instructions as shown in FIG. 18. The ACD preparation instructions more specifically include instruction on loading a set of ingredients in the automated cooking device. According to some embodiments, ingredient preparation instruction guides a user on the required ingredients and how to prep the ingredients before loading. Instructions on loading a set of ingredients guide a user on when and how to supply the ingredients to the ACD. Once the ingredients are loaded into the proper containers, the user may start the cooking process using the application on the smart mobile device.

In one variation, the user instruction portion of the automated cooking recipe can be in a machine readable format that can be translated into a user interface. Presenting user instructions can include processing the user instructions of the automated cooking recipe and rendering instructions in a controller. The user instructions are preferably interpreted to setup and operate a rendered user interface. Rendering instructions can include displaying textual instructions; media-based representations of an instruction (e.g., a graphic, animation, video, or audio), as well as interactive control flow. An application controller and, in particular, a recipe instruction interface can use any suitable user interaction flow or technique in presenting the ingredient preparation instruction or instruction on loading a set of ingredients.

The user instruction can include programmatic aspects such as variables, selectable options, and other controllable parameters. In one variation, a recipe can include a serving size variable. Detecting a change in the serving size results in a corresponding change in the ingredient quantities rendered to the user. The ingredient quantity calculations are preferably a linear relationship, but can use any suitable serving size conversion. A recipe can include other options such as a set of dietary restriction variations, a healthiness rating variations, flavor variations. Dietary restriction variations can enable a recipe to be easily translated into other versions based on dietary restrictions. For example, a standard recipe including meat may also have a vegetarian version, gluten free version, kosher version, or any suitable version of the recipe. S1milarly, a recipe could have a standard version and a healthier version that uses substitute ingredients and ingredient quantities. As an example of a flavor variation, an option may be enabled to allow a recipe to toggle between a spicy version and a mild version.

The ingredient preparation instructions can be substantially similar to any type of cooking recipe instruction. Exemplary ingredient preparation instruction can specify cutting ingredients, marinating ingredients, mixing ingredients, or any suitable culinary preparation of one or more ingredients.

ACD preparation instructions preferably provide direction on how and when to load an ingredient in the ACD. ACD preparation instructions may additionally provide instruction on other ACD setup tasks such as adding different attachments or changing settings of an ACD. As described below the ACD preparation instructions are preferably displayed through a sequential set of instructions. Providing the ACD preparation instructions preferably includes directing the loading of an ACD with at least two ingredients and ingredients for at least two stages of a cooking process. For example, providing instruction on loading of a set of ingredients in an automated cooking device can include providing instruction on loading a first set of ingredients in a first ingredient container and providing instruction on loading at least a second set of ingredients in a second ingredient container as shown in FIG. 19. Additionally, the ACD preparation instructions can direct the grouping of ingredients within one ingredient container. For example, providing instruction on loading a first set of ingredients in a first ingredient container can include presenting an instruction to load a first ingredient in the first ingredient container and subsequently presenting an instruction to load a second ingredient in the first ingredient container as shown in FIG. 20.

Preferably, the instructions on loading the ingredients are staged directions wherein delivering the instructions includes sequentially progressing an interface through a set of user instructions. The method can additionally include correlating detected interactions with the ACD with a currently displayed user instruction. More specifically, loading of an ingredient in the ACD is correlated with a currently active user instruction, which can function to implicitly identify loaded ingredients as shown in FIGS. 19 and 20. For example, if ingredients are loaded into the ACD while the current user instruction is “load the carrots”, then loaded ingredients can be identified as carrots. In a first variation, identifying an ingredient can enable individual ingredient quantity to be detected, and ingredient quantity detection can be used to refine nutritional information for a prepared recipe. Additionally, ingredient detection can be used in error correction. The method can include issuing an alert when improper loading of an ingredient is detected. One case of improper ingredient loading can occur when an ingredient is supplied to an incorrect container. As yet another variation, ingredient detection by the ACD can be used to automatically progress an instruction of the application controller as shown in FIG. 20.

Once a user completes following the user instructions, the ACD is preferably prepared to take over and automate the next part of recipe preparation. In one variation, a user can activate the ACD after completing the user instructions. The user may activate the ACD through the controller application or a control panel of the ACD. User activation of the ACD can happen locally (in the same room or house as the ACD) or remotely at any suitable location. Activation may additionally be automatically triggered after completing the user instructions. In another variation, the method includes setting an activation condition and activating the ACD upon satisfying the condition. The condition could be a time condition such as timer countdown or a specified time. The activation condition may alternatively be based on location or other factors. In one implementation, a user can set an activation condition wherein the ACD activates when a user leaves a place of work after a particular hour.

Block S140, which includes directing a cooking routine of the ACD, functions to execute cooking tasks by the ACD, which functions to translate cooking instructions into cooking tasks that make up the cooking routine. Cooking instructions are preferably associated with the selected automated cooking recipe and are machine readable instructions. The cooking routine is the sequence of cooking tasks executed when processing cooking instructions. As shown in FIG. 21, cooking instructions can be parameterized to characterize different operations and the conditions of the operations. The cooking instructions can be a script, machine readable code, compiled instructions, or any suitable data format that can be translated into actions by the ACD. Accordingly, the method can additionally include communicating cooking instructions to the ACD. The cooking instructions can be transferred directly from a controller application to the ACD, but may alternatively be obtained by the ACD via the smart cooking platform through a network connection. The cooking instructions can be transferred at any suitable time.

The ACD preferably sequentially processes cooking instructions and executes the cooking actions at the appropriate events. The sequence of cooking tasks can be time based. The sequence of cooking tasks can additionally or alternatively be temperature based, visual inspection based, or based on any suitable detectable condition. Directing a cooking routine can include modulating temperature, dispensing ingredients from one or more container, physically manipulating contents of a cooking vessel (stir, whip, turn, flip, rotate, mash, etc.), waiting, and/or executing any suitable cooking action as shown in FIG. 22. The exact cooking tasks can vary depending on the type of ACD. A stovetop ACD may be able to control a heating element applied to a cooking vessel. An oven ACD may be able to control the oven temperature. In a preferred implementation the ingredient dispensing system is selectively activated at different stages to dispensing an ingredient or groups of ingredients into a cooking vessels at the appropriate stage.

Directing a cooking routine can additionally include notifying a user device of cooking updates. The cooking updates can include completion time estimates, cooking stage information (e.g., “cooking meat”, “simmering”, etc.), errors or warnings, completion alerts, or any suitable type of notification.

### 4. Methods for Nutritional Information

As shown in FIG. 23, the method may alternatively or additionally be applied to tracking nutritional information of a prepared recipe. Further more, the method can track nutritional information over time to compile a nutritional profile. The nutritional profile can be used in augmenting the use of the SCS. Accordingly, a preferred embodiment of the method can include calculating nutritional information from preparation of an automated cooking recipe S150. Block S150 can function to automatically capture and calculate nutritional details for each recipe cooked using the ACD. Calculation of nutritional information can account for nutritional details for each ingredient, individual measurements of an ingredient or sub-groups of ingredients, and user selected recipe alterations. Ingredient nutritional details and recipe nutritional information can include calories, calories from fat, saturated fat, trans fat, cholesterol, sodium, carbohydrates, dietary fiber, sugars, protein, vitamins, iron, and/or other nutritional aspects. The nutritional details may additionally be used in generating a predicted nutritional information as shown in FIG. 33. The nutritional details of individual ingredients are preferably stored or accessible to calculate the nutritional information of a particular instance of a recipe preparation. Ingredient weight and other factors can additionally be accounted for or made accessible to convert between ingredient container measurements and the nutritional detail quantity metric. Once nutritional data is collected, the system may be able to provide a variety of feedback to the user based on the collected nutritional data.

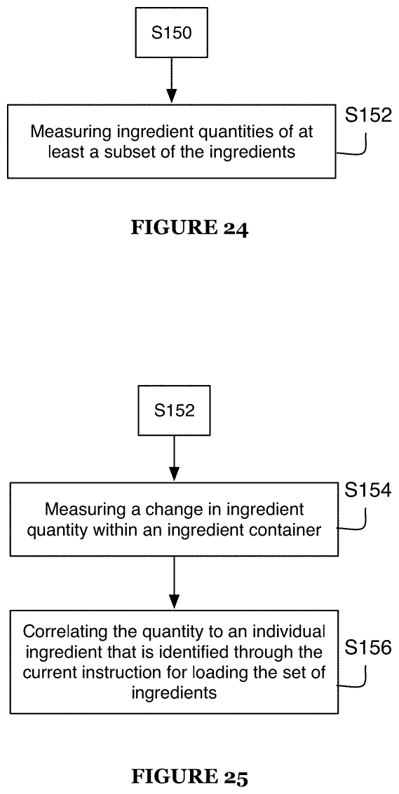

Preferably the method includes measuring ingredient quantities of at least a subset of the ingredients S152, which functions to enable the calculation of nutritional information of the recipe to be calculated at least in part according to measured ingredient quantities as shown in FIG. 24. By independently measuring the volume/weight of each ingredient, some embodiments may be able to provide the advantage of being able to accurately measure the amounts of each ingredient in the event that users modify the amounts of ingredients in a manner different from the suggested amounts as specified by the user instructions. Further, even if different users have different understandings/interpretations of ingredient amounts, the method may still be able to accurately measure the amounts of each ingredient. As an example of a different interpretation of an ingredient amount, the volume and/or the weight of “one cup of flour” may vary from user to user. A sensor, a set of sensors, or any suitable detector integrated with the ACD can be used in obtaining the measurement. Preferably the measurement occurs for ingredients added to an ingredient container. Measuring ingredient quantities can include weighing loaded ingredients, detecting volume of added ingredients, visually inspecting and approximating through a vision system, or measuring through any suitable manner.

In one variation, measuring ingredient quantities of an individual ingredient comprises measuring a change in ingredient quantity within an ingredient container S154 and correlating the quantity to an individual ingredient that is identified through the current instruction for loading the set of ingredients S156 as shown in FIGS. 20 and 25. In this preferred implementation the presentation of user instructions on how to prepare the ACD are coordinated such that the added ingredient can be deduced based on which ingredient the user instructions are telling the user to add. As an exemplary scenario, presenting the user instructions will preferably initially guide a user to prepping the ingredients. Then the recipe instruction interface can step the user through how to load the ingredients. For example, a first instruction may be displayed stating, “load the broccoli to container one”. The ACD will preferably detect some ingredient quantity change in container one and assign that quantity to the broccoli ingredient. After receiving acknowledgement of completion the recipe instruction interface can display instructions on loading the next ingredient such as “load the carrots to container one”. In this manner each ingredient can be measured. Further, the measuring by the ACD can be transparent to the user. In one variation, a user activates a button to proceed to the next ingredient loading instruction. Alternatively, measuring the ingredient may initiate automatically displaying the next ingredient loading instruction. In the example, when the ACD detects that an ingredient has been added to container one, the recipe instruction interface can automatically proceed to a subsequent step as shown in FIG. 20. In one variation, the SCS can detect ingredient variations and alert the user or take any suitable action. For example, if the user adds twice as much broccoli as expected, the recipe instruction interface can alert the user of the unexpected ingredient quantity, which can function to identify user errors or account for user modifications of a recipe. If the user confirms the unexpected ingredient quantity is intentional the SCS can update the user instructions and/or cooking instructions. For example, the ingredient loading instructions may be restructured to accommodate the increased or decreased quantities, and cooking times and temperatures may similarly be adjusted. Additionally, ingredient quantities can be recorded and used during later preparation of the recipe. For example, if a user uses 3 tablespoons of sugar instead of the recommended 2 tablespoons, then during a subsequent preparation of the recipe, the previous amount used can be displayed alongside or in place of the recommended 3 tablespoons. Displaying of past recipe modifications can additionally be conditionally displayed according to the nutritional impact of the modification. For example, the above 2 tablespoons of sugar in place of 3 tablespoons may be displayed to a user, but if the user previously used 4 tablespoons of sugar then only the recommended amount of 3 tablespoons may be displayed.

The measured ingredient quantities preferably correspond to a single ingredient. For example, the specific weight of broccoli supplied to an ACD of a recipe can be measured. Block S152 may additionally or alternatively measure groups of ingredients, which can be used in approximating an individual measured quantity for an ingredient. In some cases, ingredients may be added in a mixed or combined form. For example, two ingredients that have been blended before adding to an ingredient container may not be measured individually. In this scenario, the nutritional information for the two ingredients can be measured by weighing the blended mixture and then using the recommended ratio of ingredients to approximate an individual ingredient measurement.

The nutritional information of a prepared recipe can be displayed to user, communicated to another service, or used in any suitable manner. The method preferably includes adding the nutritional information of the prepared recipe to a nutritional profile of an account S160, which functions to create a historical record of the nutritional information. The account can be for an individual user or the device. In one variation, the nutritional information of a prepared recipe can be divided between a set of users and the associated nutritional information can be added to the respective accounts. For example, if three people evenly split a dish from the SCS three ways, the nutritional information can be divided in thirds and synced to each of their accounts. The account may alternatively be based on a home's SCS system. For example, each ACD or set of ACDs used within a home may be associated with one SCS account.

A nutritional profile can be stored locally, but is preferably stored in a remote smart cooking platform. The ACD or the controller application preferably sends the nutritional information to an online platform to record the nutritional information within a nutritional profile. Account authentication over an API is preferably used when adding nutritional information to an account profile on a remote online platform.

The nutritional profile can be a record of information from different meals at different times. The nutritional profile may additionally be supplemented with additional data sources. Nutritional trends and other patterns can be generated through a nutritional profile. In one variation multiple nutritional profiles of a smart cooking platform can be used in combination.

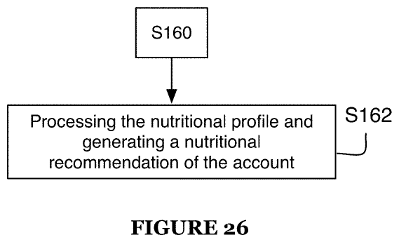

The method preferably includes processing the nutritional profile and generating a nutritional recommendation of the account S162 as shown in FIG. 26. A nutritional recommendation can be a nutritional categorization, a nutritional weighting score, or any suitable parameterizing of a users nutritional state. The nutritional recommendation preferably uses the nutritional profile information but can additionally account for personal information such as weight, sex, age, height, dietary restrictions, health conditions, and other factors. The nutritional recommendation is preferably used in promoting improved nutrition and health. A basic nutritional recommendation may score a user on a scale of 1 to 5 from unhealthy to healthy. Another nutritional recommendation may indicate how the user compares to nutritional guidelines across multiple categories. One category may indicate if the user is eating more or less than the recommended number of calories. Another category may indicate if the user is eating a diet too heavy or too light in protein. The nutritional recommendation can be used as an input in various algorithms for making recommendations, sorting recipes, or performing other tasks.

In a preferred variation, the automated cooking recipe includes ingredient nutritional details. The ingredient nutritional details can be used in combination with a measured quantity amount to calculate nutritional contribution to a prepared recipe. Preferably the nutritional contribution of each ingredient (either calculated individually or as a group) is combined to create the recipe nutritional information for that particular preparation The ingredient nutritional details can be used for calculating nutritional information for ingredients that can't be or for some other reason are not measured. Calculated nutritional contribution (based on measured ingredient quantities) and predicted nutritional contribution (based on instructed ingredient quantities) can be used in combination. The ingredient details can additionally be used in accounting for user recipe alterations and newly created recipes.

In one variation, calculating nutritional information of the recipe is calculated at least in part according to user recipe alterations. In this variation, the user recipe alterations are preferably received through the controller application. The method can additionally include generating updated user instructions according to the user recipe alterations. User recipe alterations can include setting serving size preference. Serving size preference preferably scales out the ingredient quantities specified in the user instructions and expected when measuring the ingredients. User recipe alterations can additionally include ingredient substitutions. For example, an option may exist to make a recipe chicken-based or vegetarian. S1milarly, user instructions are updated to reflect the ingredient substitution, and the calculation of nutritional information preferably accounts for the change in ingredients.

5. Method for using a Recipe Marketplace

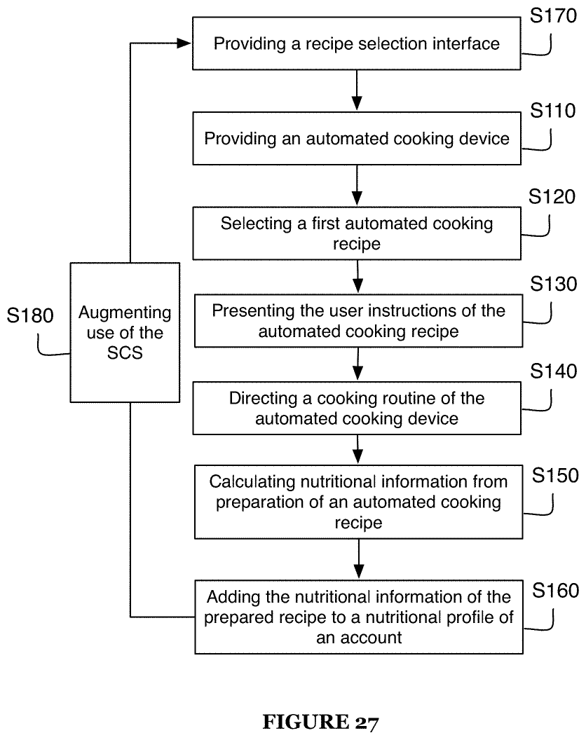

As shown in FIG. 27, the method may alternatively or additionally incorporate integration with a recipe store, marketplace, or social network. The method preferably includes providing a recipe selection interface S170, which functions to offer a channel through which recipes can be browsed, shared, accessed, purchased, or otherwise discovered. The automated cooking recipe is preferably selected from the recipe selection interface. The recipe selection interface preferably includes a set of recipes, which may be stored locally or accessed from an online source (e.g., the smart cooking platform). Providing a recipe selection interface can include providing search and browsing tools, recipe curation tools (e.g., favoriting, following, rating, adding to collections, etc.), recipe sharing tools, and other suitable features of a marketplace and/or social network.

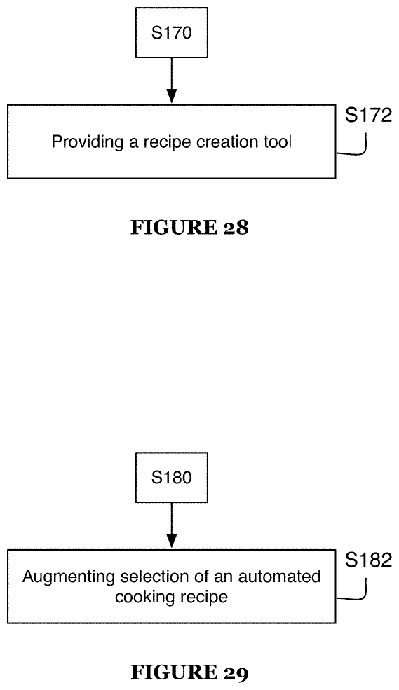

The recipes presented through the recipe selection interface can be recipes generated by the operators of the SCS. The recipes may alternatively be recipes from chefs, restaurants, companies, users, or any suitable source. In one variation, the method additionally includes providing a recipe creation tool S172 as shown in FIG. 28. The recipe creation tool functions to generate an automated cooking recipe, wherein the created automated cooking recipe can define user instructions and device cooking instructions. The automated cooking recipe may additionally support user alterations such as updating serving size or substituting ingredients. The recipe creation tool may be used as a standalone application. For example, a user may create a customized recipe without ever sharing the recipe. The recipe creation tool is more preferably used in distributing a created recipe and making the created recipe selectable through the recipe selection interface. For example, a chef can create a new recipe; define the recipe through the recipe creation tool; and then distribute the recipe through a recipe store accessed by other users through the recipe selection interface.

In an exemplary implementation, the recipe creation tool can provide user interface elements to define an automated cooking recipe through 5 sub-processes: defining ingredient preparation instructions, defining ACD loading instructions, defining ACD cooking instructions, defining recipe nutritional details, and defining recipe information. Defining ingredient preparation instructions can enable the ingredients, the ingredient quantities, and ingredient preparation steps to be defined. The ACD loading instructions are used in defining how ingredients are loaded into the ACD. They also define the ingredient dispensing options when defining the ACD cooking instructions. The ACD cooking instructions is the sequence or process for performing cooking tasks. The recipe nutritional details are preferably automatically generated but in some cases unknown ingredients or custom ingredient combinations may require a user to enter some or all nutritional details. For example, if a recipe calls for a brand name product, the user could enter nutritional details for that brand name product such that nutritional information can be calculated while accounting for the product's nutritional contribution. The recipe information can be supplemental information and meta data. The variations sub-processes can additionally accommodate recipe options. For example, ingredient options can be configured through the recipe creation tool.

In one variation, some of the sub-processes may be automatically completed through user input in another sub-process. For example, the user instructions will define the set of ingredients used in the recipe. The set of ingredients (and alternative ingredient sets) then can be used in accessing nutritional details of the set of ingredients. S1milarly, by defining the ACD cooking instructions, the ACD loading instructions may be automatically generated based on the defined ingredient delivery stages and cooking task order.

As shown in FIG. 8, a drag-and-drop user interface can be used to define the various steps. The different types of cooking tasks can be user interface objects that can be rearranged in a recipe construction canvas. Each cooking task can have editable variables. A stovetop ACD may include a change temperature object, mix object, dispense object, a wait object, and a condition object. The change temperature object can enable different temperatures to be set, different heating profiles (heat fast, heat slow), or perform any suitable heating task. The mixing object can include variables to define mixing speed, duration, mixing pattern (bursts, pulse, continuous, etc.), or other mixing aspects. The dispense object can include variables to define which ingredient to dispense or which ingredient container to dispense, the quantity to ingredient, the rate of dispensing (e.g., pour vs slowly add), or any suitable dispensing aspect. The wait object can include a variable to define how long to wait. The condition object may allow different aspects to be conditionally met before proceeding to a different step. In some cases the recipe process may not be linear. The conditional object can be used to conditionally perform one or more other cooking tasks.

As shown in FIG. 5, a recipe-recording interface can be used to partially generate a recipe automatically. A recipe-recording mode can enable the ACD to be put into a manual control mode. A user can provide basic configuration or setup. For example, the user can enter the ingredients and load the ingredients into the different containers. Then the user can start a recording and manually initiate the different cooking tasks. An automated cooking recipe can be saved after completing the cooking process.

### 6. Method for Augmenting ACD Interactions

As shown in FIG. 27, the method may alternatively or additionally be include augmenting the usage of the SCS according to user alterations during recipe preparation and/or the nutritional profile S180. Augmenting usage of the SCS is preferably done to promote enhanced nutrition, but may alternatively be used to create a customized experience.

In a first variation, block S180 can include augmenting selection of an automated cooking recipe S182 as shown in FIG. 29. The recipe selection interface is preferably altered according to the nutritional profile of a user accessing the recipe selection interface. More preferably, the nutritional recommendation of a user is used in altering presentation of the recipe selection interface. For example, the set of recipes presented to a user can be customized to promote enhanced nutrition according to the nutritional recommendation. For example, if a user has recently been preparing dishes high sodium, low-sodium recipes may be recommended. In one implementation, only recommended recipes may be displayed. In another implementation, recipes may be sorted according to a recommendation priority—a user may be allowed to navigate to a less than ideal recipe. In yet another exemplary implementation, promoted or featured recipes may be particularly recommended for a user.

In a second alternative, block S18o may include augmenting at least a portion of the user instructions and cooking instructions according to the nutritional profile S184 which functions to use the nutritional profile to alter subsequent use of the SCS as shown in FIG. 3o. As described, the automated cooking recipes of a preferred embodiment may include programmatic aspects wherein ingredients can be substituted and quantities varied. Additionally, the cooking instructions can be automatically altered according to configuration of a recipe. Accordingly, presenting user instructions and/or cooking instructions (i.e., recipe preparation) can be altered to accommodate altered nutritional goals. Changes can be made to automatically make a prepared recipe healthier. Recipe preparation can use default user instructions and cooking instructions. When the nutritional habits of a user (as may be indicated by the nutritional recommendation) are in good standing, the default recipe preparation may be used. However, if the nutritional profile and more specifically a nutritional recommendation indicate at least one aspect of a user's nutrition needs attention, a recipe preparation can be altered to support the nutritional recommendation. In some cases, ingredient quantities can be increased or decreased, an ingredient can be substituted for another ingredient, an ingredient can be added, an ingredient can be removed, and/or any suitable change may be made. Additionally the cooking instructions may be altered in some instances to enhance nutritional value based on the cooking process. This variation maybe used in combination or separately from the augmented selection variation described above.

In a third alternative, block S180 can include receiving user alteration input during recipe preparation S186 and updating at least a portion of the user instructions and cooking instructions S188 as shown in FIG. 31. A user alteration input may be made through the controller application. For example, receiving user alteration input can include receiving customization input at the recipe instruction interface. The customization input can be associated with serving size options, ingredient quantities, ingredient substitution options, food preparation preferences (e.g., well done vs. rare), and/or any suitable type of recipe modification. For example, a preference for the pasta consistency (e.g., adente vs. well-done) or meat cooking (e.g., rare vs. medium well) can be selected through a user selection input in the recipe instruction interface. Such user alterations are processed and used to generate updated user instructions and/or cooking instructions. Updated user instructions are preferably reflected in the presented user interface. Cooking instructions can additionally be updated when necessitated by the change. For example, substituting beef for chicken may alter a cooking temperature and time. User alteration input may alternatively be detected through measuring of ingredients as described above.

While the method above describes a process of use for a SCS for a single meal, the SCS can be used any suitable number of times. Additionally, the use of multiple SCSs by various users can be performed. At least a partial set of data can be collected across the plurality of uses for different meals and for different users. The collected data can be used in augmenting use of the SCS. For example, a recipe can be automatically updated to correspond to user preference for preparing a particular recipe. For example, if most people use a higher quantity of a particular ingredient, the recipe can be automatically or semi-automatically updated. In one variation, the method can include collecting user feedback for a prepared recipe. For example, after completing a recipe and eating the meal, the user can review the recipe. The feedback can be a rating. The feedback may be selection of particular critiques such as “too bland”, “just right”, “overcooked”, and the like. The feedback may alternatively be submitted in any suitable format.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
selecting a first automated cooking recipe associated with user instructions and device cooking instructions;
presenting the user instructions through a first controller device, which comprises providing ingredient preparation instruction and providing instruction on loading a set of ingredients in an automated cooking device;
delivering cooking instructions of the automated cooking recipe to the automated cooking device; and
directing a cooking routine of the automated cooking device according to the cooking instructions.

2. The method of claim 1, wherein providing instruction on loading a set of ingredients in an automated cooking device comprises providing instruction on loading a first set of ingredients in a first ingredient container and providing instruction on loading at least a second set of ingredients in a second ingredient container.

3. The method of claim 2, wherein providing instruction on loading a first set of ingredients in a first ingredient container comprises presenting an instruction to load a first ingredient in the first ingredient container and subsequently presenting an instruction to load a second ingredient in the first ingredient container.

4. The method of claim 3, wherein directing the cooking routine comprises activating an ingredient dispensing mode of the first ingredient container during a first stage of the cooking routine and activating an ingredient dispensing mode of the second ingredient container during a second stage of the cooking routine.

5. The method of claim 2, wherein the automated cooking device is a stovetop cooking device, wherein directing the cooking routine comprises, for at least one stage of the cooking routine, setting the temperature of a heating element of the automated cooking device.

6. The method of claim 1, further comprising calculating nutritional information of the recipe according to recipe preparation when presenting user instructions or directing the cooking routine.

7. The method of claim 6, further comprising measuring ingredient quantities of at least a subset of the ingredients and wherein calculating nutritional information of the recipe is calculated at least in part according to measured ingredient quantities.

8. The method of claim 7, wherein measuring ingredient quantities of an individual ingredient comprises measuring a change in ingredient quantity within an ingredient container and correlating the quantity to an individual ingredient that is identified through the current instruction for loading the set of ingredients.

9. The method of claim 6, further comprising receiving user recipe alterations and generating the user instructions with the user recipe alterations; and wherein calculating nutritional information of the recipe is calculated at least in part according to user recipe alterations.

10. The method of claim 6, further comprising adding the nutritional information of the prepared recipe to a nutritional profile of an account.

10. method of claim 10, further comprising processing the nutritional profile and generating a nutritional recommendation of the account.

12. The method of claim 11, comprising augmenting at least a portion of the user instructions and cooking instructions according to the nutritional recommendation.

13. The method of claim 11, further comprising providing a recipe selection interface from which the automated cooking recipe is selected; and altering a set of recipes presented in the recipe selection interface according to the nutritional recommendation of the account.

14. The method of claim 1, further comprising providing a recipe creation tool wherein a created recipe is distributed and made selectable through a recipe selection interface.

15. The method of claim 14, wherein at a recipe creation tool, user instructions and device cooking instructions are generated for a created recipe.

16. A method comprising:
providing an automated cooking device with a staged ingredient dispensing system;
providing a recipe selection interface of a controller application;
at the recipe selection interface, receiving selection of a first recipe;
at a recipe instruction interface, presenting instructions for recipe preparation comprising displaying a set of user instructions to load ingredients in the staged ingredient dispensing system;
at the automated cooking device, detecting the ingredient quantities of at least a subset of loaded ingredients and correlating an ingredient quantity with a first ingredient identified according to the displayed user instruction; and
calculating nutritional information from preparation of the recipe; and
compiling the nutritional information into a nutritional profile of an account.

17. The method of claim 16, further comprising:
delivering cooking instructions of the automated cooking recipe to the automated cooking device; and
directing a cooking routine of the automated cooking device according to the cooking instructions.

18. The method of claim 17, altering a set of recipes presented in the recipe selection interface according to the nutritional profile of the account.

19. The method of claim 17, further comprising generating a created recipe from a recipe creation tool, wherein the recipe includes user instructions and device cooking instructions; and wherein the selected recipe is the created recipe; and wherein calculating nutritional information from preparation of the recipe comprises calculating nutritional value from preparation of the created recipe.

20. The method of claim 19, further comprising receiving user recipe alterations and generating user instructions accounting for the user recipe alterations; and wherein calculating nutritional information according to preparation of the recipe is calculated at least in part according to the user recipe alterations.
